(19) United States
(12) Patent Application Publication
(10) Pub. No.: US 2004/0136811 A1
(43) Pub. Date: Jul. 15, 2004

(54) Extruded wire nail having locking channels

(76) Inventor: Peter B. Tarlton, Rumson, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/339,583

(22) Filed: Jan. 9, 2003

(51) Int. Cl. F16B 15/00

(52) U.S. Cl. 411/451.4

(57) ABSTRACT

A fastener such as a nail is provided, having a shaft affixed at a first end to a head and tapering to a sharp point at a second end. At least one partially enclosed locking channel is defined along the length of the shaft and is approximately three-quarters enclosed to surround fibers of a work piece.

### FIELD OF THE INVENTION

The invention generally relates to fasteners, and more specifically relates to extruded wire nails.

### BACKGROUND OF THE INVENTION

Wire nails are well known fasteners for wooden members and are designed to suit many needs, such as increasing holding strength or reducing material usage. However, existing nail technology may prove insufficient to meet these needs in many ways.

For instance, when driven into a wooden member, the standard nail cylinder compresses the fibers of the wooden member predominantly at the top and bottom of the nail shaft only. The wood is therefore effectively locked at only two points along the nail, allowing the nail to eventually loosen its mechanical grip on the wood. Furthermore, standard cylinder nails offer no angular torque resistance; that is, they may spin or rotate in place, causing them to “walk” or lose their grip on the wood fibers. This compromises the function of the nail and may reduce its useful life.

The prior art nails can also cause splitting or cutting of the wood along the grain. For example, a common round, square or rectangular nail, when driven into wood, tends to drive the grain apart or to split the same, creating a “fish-eye” condition of the grain around the nail shank. Thus, frictional contact between the common nail and the wood is less than complete, and there is no tight fit about the shank, thus reducing the holding strength of the nail driven into the wood.

More recent nail designs have attempted to address this shortcoming in the prior art by creating nails with channels or grooves along the shaft. These channels function as a locking mechanism, adding additional compressive force to the wood fibers trapped therein along the length of the channel. They also give greater torque resistance to the nail, reducing rotation within the wooden member. Grooved nail shafts have been described, for example, in U.S. Pat. Nos. 4,755,091 and 4,973,211, issued Jul. 5, 1988 and Nov. 27, 1990, respectively, to Potucek.

However, while the grooved nail shafts referred to above may substantially reduce the likelihood of a nail pulling out of or rotating within a wooden member, the additional compressive force applied by these channels is limited due to the fact that they feature an “open” design (i.e., open toward the surface and fibers of the wooden member beyond the nail shaft). That is, the channels of the prior art nails are generally formed by diverging straight edges, forming an angular channel such as a rectangle or V-shape. Thus, the compressive force is directed away from the core of the nail, toward the outer diameter of the shaft and the wood fibers beyond. Therefore, there may still be a chance that the nails will pull out of the wooden member if the force of the “lock” is not sufficient to resist an opposing force.

Thus, there is a need in the art for a nail that locks into a wooden member in a way that provides the most effective compressive force per area of material held within. It is also desirable to provide a nail that can resist angular torque when driven into a wooden member, to avoid nail rotation or walking.

### SUMMARY OF THE INVENTION

In one embodiment, the invention provides a fastener having a shaft with first and second ends, the second end of which tapers to a sharp point. At least one partially enclosed locking channel is defined along at least part of the length of the shaft. The locking channel is designed in a manner such that it is substantially enclosed to surround fibers of a work piece.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a fastener according to one embodiment of the invention;

FIG. 2 illustrates the cross-section taken along line A-A of FIG. 1, shown from the first end of the fastener;

FIG. 3 depicts a fastener according to a second embodiment of the invention;

FIG. 4 illustrates the cross-section taken along line B-B of FIG. 3, shown from the first end of the fastener;

FIG. 5 depicts a fastener according to a third embodiment of the invention;

FIG. 6 illustrates the cross-section taken along line C-C of FIG. 5, shown from the first end of the fastener;

FIG. 7 depicts a fastener according to a fourth embodiment of the invention;

FIG. 8 illustrates the cross-section taken along line D-D of FIG. 7, shown from the first end of the fastener;

FIG. 9 depicts a fastener according to a fifth embodiment of the invention;

FIG. 10 illustrates the cross-section taken along line E-E of FIG. 9, shown from the first end of the fastener;

FIG. 11 depicts a fastener according to a sixth embodiment of the invention; and

FIG. 12 illustrates the cross-section taken along line F-F of FIG. 11, shown from the first end of the fastener.

To facilitate understanding, identical reference numerals have been used, where possible, to designate identical elements that are common to the figures.

### DETAILED DESCRIPTION

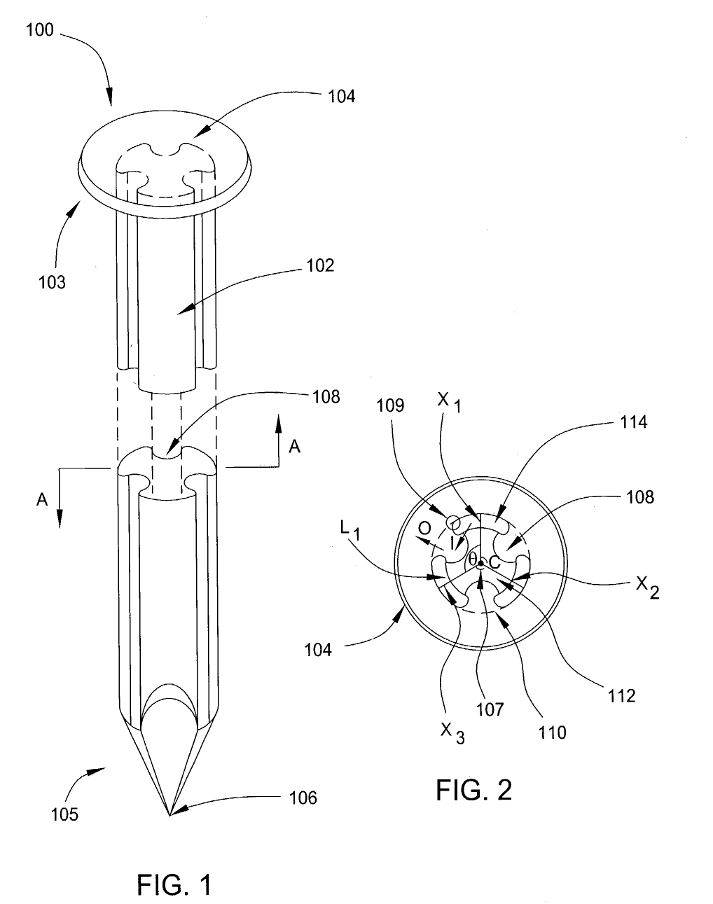

FIG. 1 depicts one embodiment of a fastener according to the present invention. The fastener 100 comprises a shaft 102, optionally affixed at a first end 103 to a head 104, and tapering to a sharp point 106 at a second end 105. In operation, force is applied to the first end 103, for example by a hammer or a pneumatic nail gun, to drive the point 106 of the fastener 100 through a work piece such as a wooden member or other non-wooden member comprised of compressible material (not shown). The fastener 100 is driven through the wooden member until all or most of the shaft 102 is disposed within the wood.

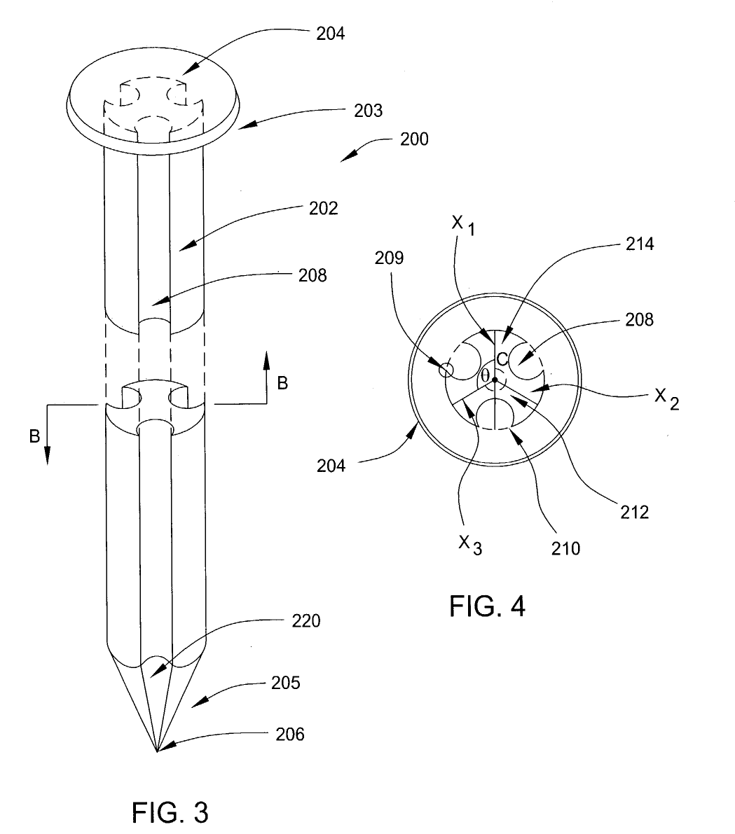

In one embodiment, the shaft 102 has a diameter equivalent to that of a standard nail and further comprises at least one channel 108 that runs along all or part of the length of the shaft 102. The fastener 100 depicted in FIG. 1 comprises 3 such channels 108. When the fastener 100 is driven into a wooden member, the channels 108 produce an inward, as well as outward, compression of the wood fibers. This effectively locks the fastener 100 into place. Furthermore, the locking mechanism produced by the channels 108 also acts to resist angular torque, preventing or reducing rotation of the fastener 100. Wood fibers are guided into the channels 108 by one or more angled guide ramps (illustrated in the perspective shown in FIG. 3 as 220) formed in the portions of the sharp point 106 that comprise ends of the locking channels 108.

The geometry of the shaft 102 and its channels 108 may be more clearly understood with reference to FIG. 2. FIG. 2 is a cross-sectional view of the shaft 102 taken along line A-A in FIG. 1 and shown from the top of the fastener 100. As illustrated, the shaft's cross-section is based on a substantially elliptical or circular shape 110 shown by a dashed outline. 110 is also, essentially, the outer diameter of the shaft 102. The cross section is uniform along the length of the shaft 102 and may be most clearly described by dividing the circle 110 into thirds defined by three 120-degree angles [symbol] . Angles [symbol] are defined by imaginary lines x₁, x₂ and x₃, which radiate from the center point C of the circle 110. Imaginary lines x₁, x₂ and x₃ extend all the way to the outer circumference of the circle 110, which is also the outer diameter of the shaft 102. Formed along the length of each line x₁, x₂ and x₃ is a flange 112 that ends in a substantially kidney-shaped projection 114 bent toward the center point C. This geometry defines three substantially C-shaped or partially enclosed channels 108 along the shaft 102. The channels 108 may be as deep as roughly one-third of the shaft's diameter. The curvature of the C-shaped channels 108 is exaggerated by one or more undercuts (or lips) 109 at each end of the “C”, that extend essentially laterally from the flange 112, along the outer diameter of the circle 110. The undercuts 109 help to trap wood fibers within the channel 108 and direct, in part, a compressive force generally inward, e.g., toward the center point C of the circle 110 (which is effectively the core of the shaft 102) and toward the walls of the channel 108. Thus, a partially enclosed space is defined, within which wood fibers are surrounded and compressed, and this partially enclosed feature of the channel achieves superior holding strength and resistance to torque.

One unique feature of fastener 100 is that the channels 108 are designed to provide both inward and outward compression of the wood fibers. Specifically, channel 108 is partially enclosed due to its C-shaped geometry and one or more undercuts (or lips) 109. The undercuts 109 cause the fibers enclosed within the channel 108 to be compressed inwardly (as illustrated by arrow l), i.e. generally toward the center point C of the shaft 102, which is effectively the shaft's core, and toward the walls of the channel 108. An amount of outward compression is also exerted by the outer edges of the undercuts 109, as illustrated by arrow O. This unique feature provides superior holding strength because the limited amount of fibers trapped within the partially enclosed channel 108 will be compressed, in part, tightly toward the center of the fastener 100. This essentially contours the wood fibers to the shaft 102, which locks the fibers and the work piece to the fastener 100. Thus, the fastener 100 achieves a superior hold. In contrast, a fastener with an “open” channel, as described above, will only exert outward compression on the fibers, and the fibers therefore may spread the compression outwardly, into the rest of work piece.

A second embodiment of a fastener 200 is depicted in FIGS. 3-4. As illustrated in FIG. 3, the fastener 200 is substantially similar to the fastener 100. The fastener 200 comprises a shaft 202, optionally affixed at a first end 203 to a head 204, and tapering to a sharp point 206 at a second end 205. The shaft 202 further comprises one or more locking channels 208 than run along at least part of the length of the shaft 202. The shaft 202 depicted in FIGS. 3-4 comprises three such channels 208. Wood fibers are guided into the channels 208 by one or more angled guide ramps 220 formed in the portions of the sharp point 206 that comprise ends of the locking channels 208.

The geometry of the shaft 202 and its channels 208 may be more clearly understood with reference to FIG. 4. FIG. 4 is a cross-sectional view of the shaft 202 taken along line B-B in FIG. 3 and shown from the first end of the fastener 200. The cross-section of the shaft 202 is essentially formed in the same way as that of the shaft 102 in FIG. 2. As illustrated, the shaft's cross-section is uniform along the length of the shaft 202 and is based on a substantially circular shape 210 shown by a dashed outline. Imaginary lines x₁, x₂ and x₃ radiate from the center point C of the circle 210 and define three 120-degree angles [symbol] . Imaginary lines x₁, x₂ and x₃ extend all the way to the outer circumference of the circle 210, which is also the outer diameter of the shaft 202. Formed along the length of each line x₁, x₂ and x₃ is a flange 212 that ends in a substantially wedge-shaped projection 214, wherein the rounded portion of the wedge 214 defines the outer diameter of the shaft 202 and the point of the wedge 214 is directed toward the center point C of the circle 210, meeting line x₁, x₂ or x₃. This geometry creates three partially enclosed, substantially C-shaped channels 208. The curvature of the C-shaped channels 208 is exaggerated by one or more undercuts (or lips) 209 at each end of the “C”, that extend essentially laterally from the flange 212, along the outer diameter of the circle 210. The undercuts 209 help to trap wood fibers within the channel 208 and direct, in part, a compressive force generally inward, e.g., toward the center point C of the circle 210 (which is effectively the core of the shaft 202), and toward the walls of the channel 208. While the undercuts 209 depicted in FIGS. 3-4 illustrate sharp edges, the undercuts 209 may alternatively feature rounded ends to minimize fiber cutting.

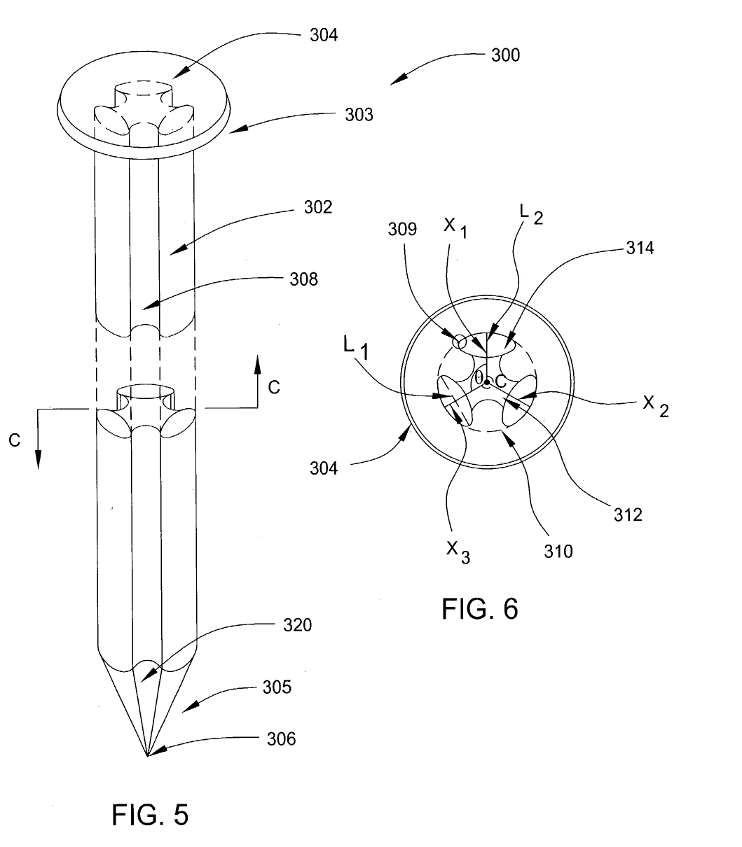

A third embodiment of a fastener 300 is depicted in FIGS. 5-6. As illustrated in FIG. 5, the fastener 300 is substantially similar to the fasteners 100, 200. The fastener 300 comprises a shaft 302, optionally affixed at a first end 303 to a head 304, and tapering to a sharp point 306 at a second end 305. The shaft 302 further comprises one or more locking channels 308 than run along all or part of the length of the shaft 302. The shaft 302 depicted in FIGS. 5-6 comprises three such channels 308. Wood fibers are guided into the channels 308 by one or more angled guide ramps 320 formed in the portions of the sharp point 306 that comprise ends of the locking channels 308.

The geometry of the shaft 302 and its channels 308 may be more clearly understood with reference to FIG. 6. FIG. 6 is a cross-sectional view of the shaft 302 taken along line C-C in FIG. 5 and shown from the first end of the fastener 300. The cross-section of the shaft 302 is essentially formed in the same way as that of the shaft 102 in FIG. 2 or 202 in FIG. 4. As illustrated, the shaft's cross-section is uniform along the length of the shaft 302 and is based on a substantially circular shape 310 shown by a dashed outline. Imaginary lines x₁, x₂ and x₃ radiate from the center point C of the circle 310 and define three 120-degree angles [symbol] . Imaginary lines x₁, x₂ and x₃ extend all the way to the outer circumference of the circle 310, which is also the outer diameter of the shaft 302. Formed along the length of each line x₁, x₂ and x₃ is a flange 312 that ends in a substantially elliptical projection 314, wherein the major axis L₁ of the ellipse 314 is positioned substantially perpendicular to the flange 312 so that it defines the outer diameter of the shaft 302. The minor axis L₂ of the ellipse is substantially collinear with lines x₁, x₂ and x₃. The channels 308 may be as deep as roughly one-third of the shaft's diameter. This geometry creates three partially enclosed, substantially C-shaped channels 308. The curvature of the C-shaped channels 308 is exaggerated by one or more undercuts (or lips) 309 at each end of the “C”, that extend essentially laterally from the flange 312, along the outer diameter of the circle 310. The undercuts 309 help to trap wood fibers within the channel 308 and direct, in part, a compressive force generally inward, e.g., toward the center point C of the circle 310 (which is effectively the core of the shaft 302), and toward the walls of the channel 308.

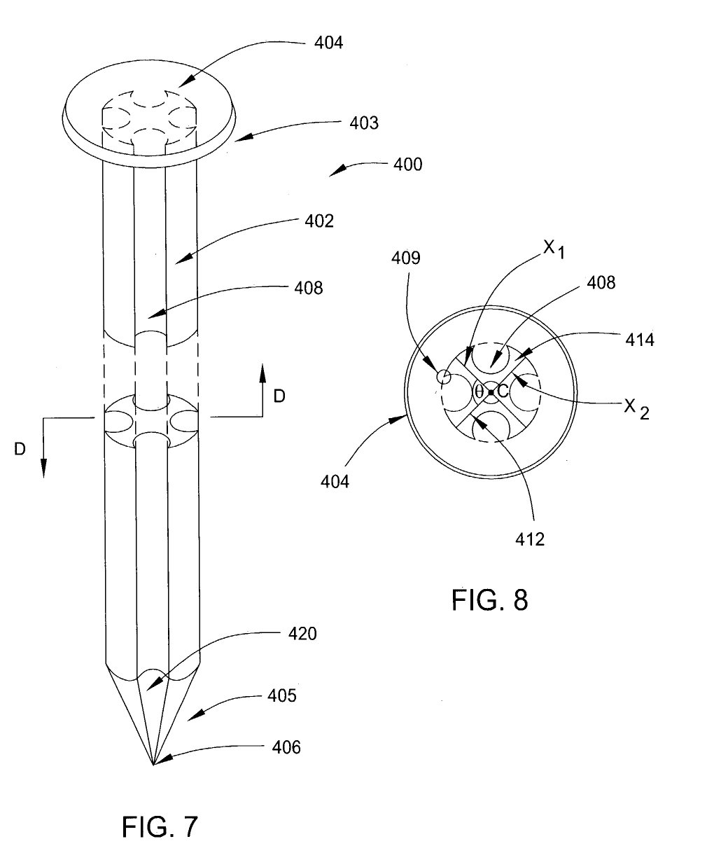

A fourth embodiment of a fastener 400 is depicted in FIGS. 7-8. As illustrated in FIG. 7, the fastener 400 is substantially similar to the fasteners 100-300. The fastener 400 comprises a shaft 402, optionally affixed at a first end 403 to a head 404, and tapering to a sharp point 406 at a second end 405. The shaft 402 further comprises one or more locking channels 408 than run along all or part of the length of the shaft 402. The shaft 402 depicted in FIGS. 7-8 comprises four such channels 408. Wood fibers are guided into the channels 408 by one or more angled guide ramps 420 formed in the portions of the sharp point 406 that comprise parts of the locking channels 408.

The geometry of the shaft 402 and its channels 408 may be more clearly understood with reference to FIG. 8. FIG. 8 is a cross-sectional view of the shaft 402 taken along line D-D in FIG. 7 and shown from the first end of the fastener 400. The cross-section of the shaft 402 is uniform along the length and is based on a substantially circular shape 410 shown by a dashed outline, much like the shafts 102-302 in the preceding figures. Imaginary lines x₁ and x₂ extend across the diameter of the circle 410 and intersect each other at the center point C of the circle 410 to define four 90-degree angles [symbol] . Formed along the length of each line x₁ and x₂ as it radiates from the center point C is a flange 412 that ends in a substantially wedge-shaped projection 414, wherein the rounded portion of the wedge 414 defines the outer diameter of the shaft 402 and the point of the wedge 414 is directed toward the center point C of the circle 410, meeting line x₁ or x₂. This geometry defines four substantially C-shaped channels 408. The curvature of the C-shaped channels 408 is exaggerated by one or more undercuts (or lips) 409 at each end of the “C”, that extend essentially laterally from the flange 412, along the outer diameter of the circle 410. The undercuts 409 help to trap wood fibers within the channel 408 and direct, in part, a compressive force generally inward, e.g., toward the center point C of the circle 410 (which is effectively the core of the shaft 402), and toward the walls of the channel 408. While the undercuts 409 depicted in FIGS. 7-8 illustrate sharp edges, the undercuts 409 may alternatively feature rounded ends to minimize fiber cutting. The channels 408 may be as deep as roughly one-quarter of the shaft's diameter. Alternatively, the projections 414 on the ends of the flanges 412 may be kidney-shaped or elliptical as described above, or may comprise another curved locking geometry such as compound curves.

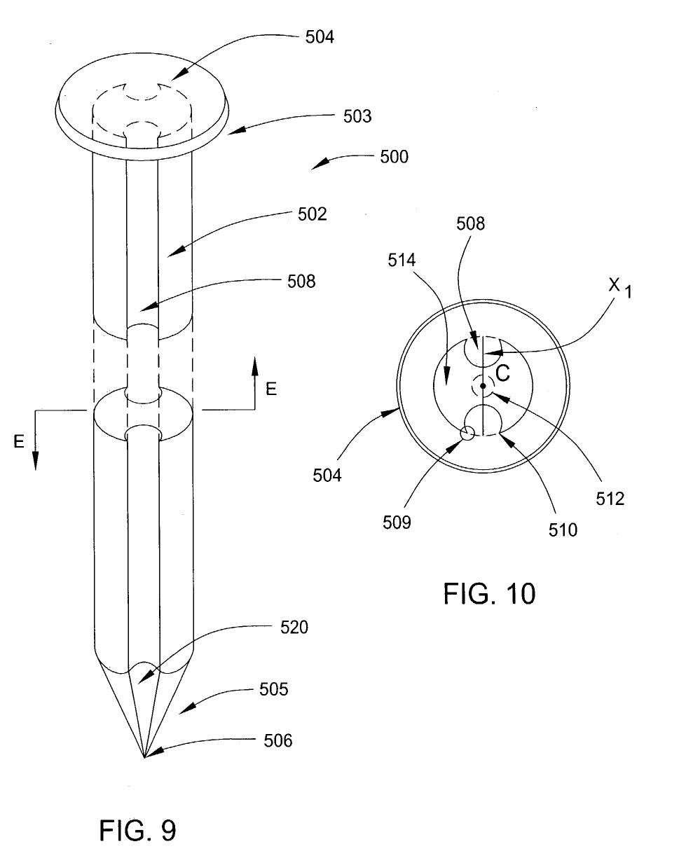

A fifth embodiment of a fastener 500 is depicted in FIGS. 9-10. As illustrated in FIG. 9, the fastener 500 is substantially similar to the fasteners 100-400. The fastener 500 comprises a shaft 502, optionally affixed at a first end 503 to a head 504, and tapering to a sharp point 506 at a second end 505. The shaft 502 further comprises one or more locking channels 508 than run along all or part of the length of the shaft 502. The shaft 502 depicted in FIGS. 9-10 comprises two such channels 508. Wood fibers are guided into the channels 508 by one or more angled guide ramps 520 formed in the portions of the sharp point 506 that comprise parts of the locking channels 508.

The geometry of the shaft 502 and its channels 508 may be more clearly understood with reference to FIG. 10. FIG. 10 is a cross-sectional view of the shaft 502 taken along line E-E in FIG. 9 and shown from the first end of the fastener 500. The cross-section of the shaft 502 is uniform along the length and is based on a substantially circular shape 510 shown by a dashed outline, much like the shafts 102-402 in the preceding figures. Imaginary line x₁ extends across the diameter of the circle 510 (the outer circumference of which is also the outer diameter of the shaft 502) to divide the circle 510 into two halves. A short flange 512 extends from either side of the line x₁ and ends in a substantially semicircular- or crescent-shaped projection 514, wherein the rounded portion of the semicircle 514 defines the outer diameter of the shaft 502. This geometry defines two substantially C-shaped channels 508. The curvature of the C-shaped channels 508 is exaggerated by one or more undercuts (or lips) 509 at each end of the “C”, that extend essentially laterally from the flange 512, along the outer diameter of the circle 510. The undercuts 509 help to trap wood fibers within the channel 508 and direct, in part, a compressive force generally inward, e.g., toward the center point C of the circle 510 (which is effectively the core of the shaft 502), and toward the walls of the channel 508. While the undercuts 509 depicted in FIGS. 9-10 illustrate sharp edges, the undercuts 509 may alternatively feature rounded ends to minimize fiber cutting. The channels 508 may be as deep as roughly one-quarter of the shaft's diameter. Alternatively, the projections 514 may be kidney- or wedge-shaped or elliptical as described above, or may comprise another curved locking geometry such as compound curves.

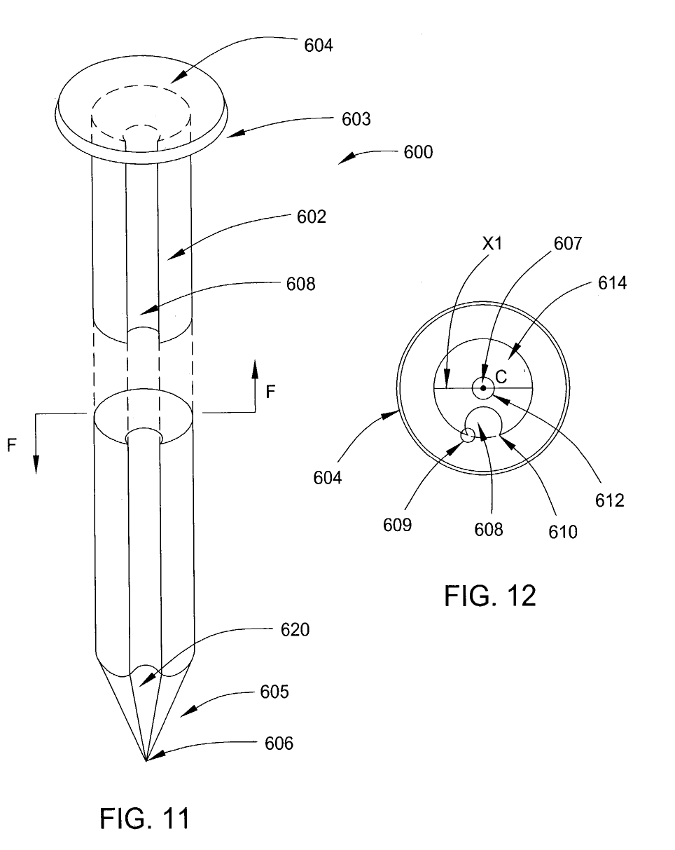

A sixth embodiment of a fastener 600 is depicted in FIGS. 11-12. As illustrated in FIG. 11, the fastener 600 is substantially similar to the fasteners 100-500. The fastener 600 comprises a shaft 602, affixed at a first end 603 to a head 604 and tapering to a sharp point 606 at a second end 605. The shaft 602 further comprises one or more locking channels 608 than run along all or part of the length of the shaft 602. The shaft 602 depicted in FIGS. 11-12 comprises one such channel 608. Wood fibers are guided into the channel 608 by an angled guide ramp 620 formed in the portion of the sharp point 606 that comprises an end of the locking channel 608.

The geometry of the shaft 602 and its channel 608 may be more clearly understood with reference to FIG. 12. FIG. 12 is a cross-sectional view of the shaft 602 taken along line F-F in FIG. 11 and shown from the first end of the fastener 600. The cross-section of the shaft 602 is uniform along the length and is based on a substantially circular shape 610 shown by a dashed outline, much like the shafts 102-502 in the preceding figures. Imaginary line x₁ extends across the diameter of the circle 610 (the outer circumference of which is also the outer diameter of the shaft 602) to divide the circle 610 into two halves. A substantially C-shaped channel 608 is cut into one half of the circle 610. The curvature of the C-shaped channel 608 is exaggerated by one or more undercuts (or lips) 609 at each end of the “C”, that extend essentially laterally from the flange 612, ,along the outer diameter of the circle 610. The undercuts 609 help to trap wood fibers within the channel 608 and direct, in part, a compressive force generally inward, e.g., toward the center point C of the circle 610 (which is effectively the core of the shaft 602), and toward the walls of the channel 608. While the undercuts 609 depicted in FIGS. 11-12 illustrate sharp edges, the undercuts 609 may alternatively feature rounded ends to minimize fiber cutting. The channel 608 may be as deep as roughly one-third of the shaft's diameter, but the depth in any circumstance must be less than one-half the diameter to leave the core 607 of the shaft 602 intact. The diameter of the core will typically depend on the desired mechanical strength of the fastener, but in any event should ideally comprise 40 to 60% of the total diameter of the fastener.

The present invention therefore represents a significant advancement in nail-type fastener design. The fasteners of the present invention produce greater, more effective compression of wood fibers by compressing both inwardly and outwardly in relation to the shaft. Thus, the wood fibers within the channels are contoured to the fastener, thereby creating a locking mechanism to hold the fastener in place and preventing or reducing rotation. Furthermore, as the cross sections of the various embodiments illustrate, the fasteners use less material than conventional nails. For example, the use of channels may allow for up to a 30% material savings per fastener. This results not only in a more cost effective design, but also in a fastener that requires less force to be driven into a wooden member. This makes construction by hand safer and reduces pneumatic wear on pneumatic nail guns.

While the foregoing is directed to embodiments of the invention, other and further embodiments of the invention may be devised without departing from the basic scope thereof, and the scope thereof is determined by the claims that follow.

What is claimed is:

1. A fastener comprising:
a shaft, having a first end and a second end, wherein said second end of said shaft tapers to a sharp point, and wherein at least one partially enclosed locking channel is defined along at least part of the length of said shaft.

2. The fastener of claim 1, wherein the sharp point further comprises at least one guide ramp for guiding fibers of a work piece into the at least one partially enclosed locking channel.

3. The fastener of claim 1, wherein said at least one partially enclosed locking channel is for surrounding fibers of a work piece into which the fastener is driven.

4. The fastener of claim 3, wherein said at least one partially enclosed locking channel is for exerting a compressive force on said fibers in a generally inward direction toward a center of said shaft and toward walls of said at least one partially enclosed locking channel.

5. The fastener of claim 4, wherein a head is affixed to said first end of said shaft.

6. The fastener of claim 4, wherein said at least one partially enclosed locking channel is defined by at least one shaped projection along said shaft.

7. The fastener of claim 6, wherein said at least one shaped projection defines said at least one partially enclosed locking channel into a curved, substantially C-shaped channel.

8. The fastener of claim 7, wherein each of said at least one shaped projection is coupled to a distal end of a flange that radiates from said center of said shaft and extends to a circumference of said shaft.

9. The fastener of claim 8, wherein said at least one shaped projection is substantially a wedge, kidney, elliptical, or semicircular shape.

10. The fastener of claim 6, wherein said at least one shaped projection further comprises one or more undercuts which extend substantially laterally along said circumference of said shaft.

11. The fastener of claim 9, wherein two flanges radiate from said center of said shaft.

12. The fastener of claim 9, wherein three flanges radiate from said center of said shaft.

13. The fastener of claim 9, wherein four flanges radiate from said center of said shaft.

14. The fastener of claim 8, wherein said at least one shaped projection comprises two substantially semicircular projections that define two substantially C-shaped channels.

15. The fastener of claim 8, wherein said at least one shaped projection comprises three substantially kidney-shaped projections that define three substantially C-shaped channels.

16. The fastener of claim 8, wherein said at least one shaped projection comprises three substantially wedge-shaped projections that define three substantially C-shaped channels.

17. The fastener of claim 8, wherein said at least one shaped projection comprises three substantially elliptical projections that define three substantially C-shaped channels.

18. The fastener of claim 8, wherein said at least one shaped projection comprises four substantially wedge-shaped projections that define four substantially C-shaped channels.

19. The fastener of claim 4, wherein one substantially C-shaped, partially enclosed locking channel is defined along the length of said shaft and has a depth no greater than a radius of said shaft.
